(19) United States
(12) Patent Application Publication
(10) Pub. No.: US 2010/0044290 A1
(43) Pub. Date: Feb. 25, 2010

(54) SYSTEM FOR TREATING WATER

(76) Inventor: Kenneth J. Hsu, Surrey (GB)

Correspondence Address: BREINER & BREINER, L.L.C., P.O. BOX 320160, ALEXANDRIA, VA, 22320-0160, US

(21) Appl. No.: 12/449,922

(22) PCT Filed: Mar. 7, 2007
(86) PCT No.: PCT/EP2007/052148

§ 371 Date: Oct. 28, 2009

(51) Int. Cl. C02F 9/14; C02F 1/66; C02F 1/00; C02F 9/02; C02F 3/34

(52) U.S. Cl. 210/170.09; 210/205; 210/153; 210/170.1

(57) ABSTRACT

The construction of a system including a hydrotransistor and a self-cleansing water body, which could be a construction or a part of a stream, lake or other natural water-body, to convert drinking-water sources or polluted surface waters into purified water for recycling either as drinking water supply or as groundwater recharge, wherein the articulate matter in the treated water is filtered by hydrotransistor, and the dissolved nitrates and nitrite being utilized by diatoms which have been induced to grow in waters becoming slightly acidic through the dissolution of carbon dioxide.

Water recycling should be the key to resolve the current water crisis, but the nitrite in water is the stumbling block. Dissolved nitrite salts cannot be removed on a large scale by current technology. On the contrary, waste-water treatment plants, relying on biodegradation process to remove particulate organic matter, produce large quantity of the pollutant so that the treated water is nowhere allowed to be recycled. Current practices of illegally recycling the treated water for irrigation and other purposes have led to catastrophic pollutions.

The present invention has been developed as a refinement and improvement over my former inventions. I have invented filter-hydrotransistors to remove particulate matter in polluted or waste water, so that the biodegradation is not necessary in sewage-treatment (PCT WO 2005/123597). I have further invented a method to remove the dissolved nitrite through the introduction of carbon-dioxide to self-cleansing pond in which diatoms can grow (PCT WO 2005/007586). I teach in this patent a process or system by which sources of water-supply and/or treated waste-water can be filtered through F-hydrotransistor and de-nitrified in natural self-cleansing ponds on a large scale for recycling. We teach the production of pure and clean, germ-free and non-carcinogenic Jing Water that can be bottled and sold at supermarkets, especially in places where nitrite-free water-supply is not available.

The present invention for producing purified, non-carcinogenic water economically on a large scale serves a) to eliminate pollution, b) to produce water for recycling as water-supply or as groundwater recharge, and c) to produce inexpensive and healthy drinking water for everybody. We teach in this patent also the idea to build a pipe-line system to collect industrially produced waste-gas to combat pollution.

### Health Hazard of Nitrate and Nitrite

Nitrate itself is generally not harmful to human. However, digestive processes in human body can transform nitrate into nitrite. Nitrite is a very strong reducing agent. Absorbed in the blood stream, nitrite is oxidized through its reaction with the oxygen in blood, and causes the blood vessels to lose their functions to transport oxygen. Baby blue syndrome (methemoglobinemia) is caused by exposure to very elevated levels of nitrite in infants, but the disease is rarely diagnosed in the US. A far more serious hazard is the transformation of nitrite into nitroamines, and those are proven carcinogenic in laboratory animal studies. It has been pointed out, however, that nitrite could react with the gastric acids in human stomach, so that nitrite could be eliminated before absorption take place. The alarmists found, however, by experimentation gastric absorption of nitrite in animals. Furthermore, nitrite is present in human excrements, signifying that nitrite is absorbed into the human blood stream before its completely oxidation in stomach. Those clinical arguments give credence to the conclusion of numerous statistical studies that correlate cancer mortality to nitrite in drinking water.

Foreign correspondents cited the increase of the cancer mortality, and blamed the Chinese Government: the Chinese are “paying the price for decades of environmental neglect. The accusation missed the mark. Experts in China are aware of the nitrite hazard, but the government is facing a dilemma that is faced by all governments of the World. The United States Government set a very tolerant standard, while refusing to accept the statistical correlation of cancer mortality and nitrite concentration. The Chinese Government takes a different approach. There would be no urban water supply, if an acceptable standard is set, as long as there is no technology to de-nitrify drinking water on a large scale. Under the condition, people can either take the risk or they drink “bottled purified drinking water.” For that, there is a very stringent standard. The PMCL in 1995 (GB 8537-1995) was 0.005 mg/L N in NO2 (or 0.0165 mg/L NO2-), and the PMCL in 1998 (GB 17324-1998) was reduced to 0.002 mg/L N in NO2- (or 0.0066 mg/L NO2-). Those values approach that of Zero PMCL, and are far less than the PMCL of Europe or that of the United States. “Purified drinking water” in bottles or in barrels of 19 liters each are sold in Chinese supermarkets. Osmosis is the method of de-nitrifying such “purified water.” (PMCL=permissible maximum contamination level).

### DESCRIPTION OF PRIOR DEVELOPMENTS AND BACKGROUND

Since the issue of nitrite hazard is still somewhat controversial, there is no consensus on the MCL (maximum contamination level) of nitrite in drinking water. The goal (MCLG) is, of course, nil for all potentially carcinogenic substances in drinking water, but Zero-Nitrite tolerance is not practicable, because there has been no treatment-technology to mass-produce de-nitrified water. There is no international standard on the permissible or PMCL: it is different in different countries. The very high PMCL of 1 mg/L N in NO2- in the United States has been set on the basis of early clinical studies, going back to 1950s. The UK authorities are equally relaxed about the potential risk: The PMCL for England and Wales was in fact raised in 1999, from 0.1 to 0.5 mg/L NO2- (or 0.033 to 0.165 mg/L of N in NO2-).

The MCL nitrite values of drinking water are very high everywhere in the world. A recent study of the nitrite content of Pearl River (source of Canton's water-supply) indicates, for example, not only high but steadily increasing values, from 0.12 mg/L N in NO2- in 1991, to 0.18 mg/L NO2- in 1998, a 50% increase in 7 years. The cancer mortality increased from 1240 to 1540 per million population, an increase of 25%. In other words, some three thousand more persons died of cancer in the City of Canton during those 7 years. How many of those died because their drinking water is carcinogenic?

Unable to solve the problem, the nitrite content of the Pearl River continues to rise to about 0.29 mg/L N in NO2- in 2006.5 How many more died when the nitrite was increased by another 50%? It was discovered that the tape water had even more nitrite, with values up to 0.43 mg/L N in NO2-.

The addition was related to the liquid-chlorine method of sterilization, which produced even more nitrite.

Governments of the World are facing a dilemma. One can disregard the statistical correlation of cancer mortality and nitrite concentration and set a very tolerant standard. Or one can neglect to set a nitrite standard for urban water supply, as long as there is no technology to de-nitrify drinking water on a large scale. Under the condition, people can either take the risk or they drink “purified drinking water,” and set a PMCL as low as 0.002 mg/L N in NO2-.

“Purified drinking water” in bottles are sold in Chinese supermarkets. Reverse osmosis is the method of de-nitrifying such “purified water.” The process is too expensive to be applied on a large scale for water supply. This invention to produce de-nitrified water on a large scale is the first to supply urban and rural populations with germ-free and non-carcinogenic water.

Sources of Nitrite from Pollution

The present invention was made possible after decades of studying the ecology of nitrogen cycling in Nature and of applying the physics of integrated hydrologic circuit to construct filters to eliminate nitrogen-compounds in particulate organic matter.

Recent nitrification of natural waters is anthropogenic. A major culprit is the disruption of the Nature's recycling. There is no nutrient-enrichment in pristine environments. Natural waters in mountains are, as a rule, slightly acidic. Erosion and stream transport bring nutrients N and P to mountain lakes, where the dominant plankton are the diatoms. The nutrients are taken up by the plankton, which feed aquatic animals. Fish excrements in the form of fecal pellets sink to water bottom, so that the lakes can remain clear and transparent and low in N and P. Lakes in lowland, especially in terrains underlain by limestone, tend to be alkaline. Lake water saturated with dissolved calcium bicarbonate ions keeps the lake alkaline; the lake water has an pH of about 8.3 where it is equilibrated with atmospheric carbon dioxide. The condition was, however, different in the spring, when bottom water is brought up by lake circulation. Under such normal circumstance, diatoms grow in the nutrient-rich, slightly acidic water. The diatoms blooms consume much of N and P, so that when green algae should start to grow in early summer, the lake becomes impoverished in nutrients. The population of the green algae are thus limited.

The conditions are drastically changed when sewage or treated waste-water enters a lake; the water becomes more alkaline. The increased alkalinity inhibits the growth of diatoms. More green algae would grow, to make the water even more alkaline, further favoring the blooming of the green algae. Being slightly toxic, green algae are not consumed by the fish, so that the algal population could continue to flourish until the plankton die in the winter. Their dead remains sink then slowly to lake bottom, extracting oxygen from the water column while organic debris decay. The biogenic nitrogen is oxidized in part into nitrate and nitrites and dissolved in water to make the lake even more nitrified when streams bring in more nitrogen salts. The chain reaction is thus alkalinity, growth of green algae, more alkalinity, more green algae, death and decay, oxidation of dead remains, eutrophication, and release of nutrients, such as the harmful nitrite. After “devil's cycle” continues for decades, the lake water with its nitrite hazard can no longer be suitable water-supply. Deprived of a natural process to cleanse the water every spring when diatoms grow, lakes become increasingly alkaline sewage pits for the blooms of polluting algae.

The one significant environmental difference between the diatoms and the green algae is that fish feed only on diatoms, not on green algae. The nutrients consumed by diatoms are to be embedded in sediments, and the nutrients consumed by the green algae go back to the water column. The patent teaches a modification of polluted environment so that diatoms instead of green algae become the dominant plankton.

Source of Nitrite from Sewage Treatment

Sewage-treatment plants are another major source for the nitrite in drinking water. The four components of pollution are the inorganic and organic detritus, the living micro-organisms, and the dissolved components.

Sewage-treatment plants use screens, sand filters, and sedimentation ponds to remove particulate matter. The rate is very slow, and such physical treatments are not effective. The current practice emphasizes biodegradation to remove organic debris. Organic matter is decomposed by bacteria and is converted into water and carbon dioxide, while the minor constituents N and P are released.

Biodegradation under reduced condition produces harmless nitrogen, but the process is too slow and costly so that the more efficient biodegradation by oxidation is commonly employed. Specialists in sewage-treatment seem to be oblivious of the nitrite hazard, and they are not concerned with the consequence of mass production of nitrite in treated water.

Governmental regulations prohibit the recycling of treated water, but few seem to understand that the regulation is necessary to minimize the nitrite hazard. Nitrite PMCL is not on the list for treated water, so that few treatment plants bother to make nitrite analysis. In their ignorance of nitrite hazard, water-treatment managements are aggressively promoting the re-use of treated water for irrigation. They do not seem to understand that nitrite salts remain in soil after the evaporation of the irrigating water. Studies have shown that the nitrite content in the soil of fields irrigated by recycled waste-water is twice as high as that of fields irrigated by freshwater. The nitrite in soil is then dissolved by the next rain to pollute streams and groundwater.

The present patent teaches a new process of sewage treatment that eliminates nitrite from treated water.

### De-Nitrification Process in Self-Cleansing Pond

The patent teaches the production of nitrite-free water by a) filtering through F-hydrotransistor and b) by de-nitrification in self-cleansing pond.

The invention of the hydrotransistor has been taught by my Patent Application WO 2005/123597: Aquitransistors in Integrated Hydrologic Circuit. Filtering through micro-meter sized sieve-openings serves to remove particulate matter, inorganic, organic, or living from polluted water. For effective filtering, the top layering of filtering grains consists of medium or fine silt. For fast flow-rate, a hydrotransistor consisting of perforated pipes embedded in a gravel matrix is constructed at the bottom. The filter and the hydrotransistor are separated by a protective mantle of graded sand which prevents the penetration by fine filtering-grains into the large pores of the gravel.

Filtering is a physical process, and may remove some dissolved ions attached to suspended grains. This invention teaches the complete removal of harmful dissolved component, especially nitrite and nitrate ions, by a natural process in a constructed self-cleansing pond. Two processes are involved in the de-nitrification:

1) an acidization process with the use of carbon dioxide to kill off the polluting algae and to favor the growth of diatoms to remove nitrate and nitrite from treated water (WO 2005/007586), and
2) a manufacturing process to produce carbon dioxide at room temperature to be introduced for acidization of the water self-cleansing ponds, in which diatoms are cultured for the removal of nitrate and nitrite from treated waters (PCT/CH 2006/000002).

In our discussion of the source of nitrites, we have indicated that plankton in natural waters can effectively remove nutrients from natural waters.

Algae grow by taking up ammonium and phosphate to photosynthesize to photosynthesize carbon dioxide and water, 106CO2+236H2O+16NH4++HPO42-=C106H181O45P+118O2+171H2O+14H+

The ammonium consumed by photosynthesis is compensated by de-nitrification:

NO2-+5H++3Cl—+H2O=NH4++3HClO— (acidic environment)

NO2-+3Cl—+3H2O=NH4++2OH—+3ClO— (alkaline environment)

Therefore, all plankton, diatoms in acidic and green algae in alkaline environment, can remove nitrite from natural waters. Still green algae are considered the very culprit of pollution. Why?:

As I indicated, the critical cause of pollution is not the growth, but the death of green algae. Being slightly toxic to fish, they are not a fish-feed.

After they die a natural death in winter, their remains sink to water bottom, while the organic nitrogen is converted to ammonia, nitrate and nitrite.

Whereas the partially decomposed matter gives odor, the nitrates and nitrites present the health hazard.

Fish do feed on diatoms. We have succeeded to culture diatoms in self-cleansing pond to sustain a population of shrimps and fish. After about a month, nitrates and nitrite are both removed from the filtered water. The nitrite concentration is less than 0.004 mg/L of N in NO2-: the filtered water has become a “de-nitrified drinking water.” The production cost is very little, as the de-nitrification has been accomplished in the self-cleansing pond.

To achieve the aim that the environment is not again polluted by green algae, we have to recall that photosynthesis of diatoms takes up CO2, N and P.

While nitrite is removed, the water in self-cleansing pond is rendered more alkaline. Continued dissolution of CO2 is thus necessary to maintain the slightly acidic environment to culture the growth of diatoms.

To inhibit the growth of green algae, the pH of the water should be less than below 7. All green algae are exterminated when pH of the water falls below 5.8, but the killing of algae would leave the dead remains, which have to be filtered out again. Otherwise the decomposition of dead algae would release nitrite again into water.

The sources of the carbon dioxide for the acidization of water in self-cleansing pond can be carbon dioxide in tanks, carbon produced by acidization of carbonate minerals such as magnesite, or carbon dioxide collected by a pipeline system from factories burning fossil fuels. The use of carbon dioxide emission to combat pollution of natural waters serves a dual function of alleviating the global warming by greenhouse gases.

With the construction of self-cleansing ponds containing acidized natural waters, the dissolved carcinogenic (nitrite) and potentially carcinogenic (nitrate) can be eliminated economically on a large scale, up to millions of tons daily, by the culturing of diatoms, which feed aquatic animals. Nitrite is removed through its formation of organic nitrogen in living organism. Table 1 is a comparison of the nitrite-concentration of A) a treated water from a conventional sewage plant, B) water filtered through a hydrotransistor, and C) denitrified water from a self-cleansing pond.

With such a set-up water flows very rapidly through micrometer pores of the 10-micron silt at a rate of about 10 m3/m2. Where the quality of treated water is of no great concern, very-fine sand filters are used to produce scenic water with filtering rate of more than 25 m3/m2. The treated water is clear, devoid of suspended matter, and is in almost all aspect a Grade I water suitable for recharging, except for the dissolved N and P salts.

TABLE I
Concentration of Nutrients in mg/L in Treat Water Samples

| | A | B | C |
|---|---|---|---|
| Total N | 18.89 | 2.08 | 1.24 |
| NH3 N | 1.60 | 0.12 | 0.11 |
| Nitrate-N | 9.85 | 0.1 | 0.0032 |
| Nitrite-N | 0.15 | 0.06 | 0.0004 |
| Total P | 0.23 | 0.068 | 0.346 |

### Production of Germ-Free Non-Carcigenic Jing Water

Our experimental IHC system of hydrotransistor and self-cleansing pond, constructed at a cost of about a million RMB, can filter “purified water for drinking” at a rate of 800 tons or 800,000 liters per day. The water is de-nitrified and free of intestinal bacteria, and it is produced at cost of less than 5 cents RMB per liter. We have named the water purified by this process “Jing Water” as water-supply. The hydrotransistor parts can be pre-fabricated and transported by trucks to rural or disaster-struck areas, where they are easily resembled to provide health drinking water. The Jing Water can also be bottled and sold on the market.

1-5. (canceled)

6. A system for treating water to convert said water into purified water for recycling either as drinking water supply or as groundwater recharge, comprising
a filter and a hydrotransistor for filtering water to be treated to filter out particulate matter, and
a self-cleansing pond in which dissolved nitrates and nitrites in the water to be treated are removed by a natural process comprising an acidification process including introducing carbon dioxide into the pond sufficient to kill off polluting algae and to favor growth of diatoms which substantially removes the nitrates and nitrites from the water to be treated.

7. The system according to claim 6, wherein parts of the system are disassemblable for transport and reassemblable in rural communities or in disaster areas to provide germ-free and non-carcinogenic drinking water.

8. The system according to claim 6, further comprising a pipeline system constructed and arranged to collect industrially produced waste gas containing carbon dioxide which serves as said carbon dioxide of said acidification process to acidify the water in the self-cleansing pond.

9. The system according to claim 7, further comprising a pipeline system constructed and arranged to collect industrially produced waste gas containing carbon dioxide which serves as said carbon dioxide of said acidification process to acidify the water of the self-cleansing pond.

10. The system of claim 6, wherein the water to be treated is from a lake, canal or other natural water body.

11. The system of claim 6, wherein the system removes the nitrates and the nitrites to concentrations of a standard less than that required for purified drinking water in urban and rural water-supply or as marketable bottled water.
